(19) United States
(12) Patent Application Publication
(10) Pub. No.: US 2013/0137394 A1
(43) Pub. Date: May 30, 2013

(54) SYSTEM FOR CONTROLLING ELECTRICAL ENERGY SUPPLY TO PERIPHERAL DEVICES USING PREPAID AIRTIME

(71) Applicant: Colin Stephen JORDAN, Randburg (ZA)

(72) Inventor: Colin Stephen JORDAN, Randburg (ZA)

(73) Assignee: ECONET WIRELESS IP HOLDINGS LIMITED, Randburg (ZA)

(21) Appl. No.: 13/546,889

(22) Filed: Jul. 11, 2012

(30) Foreign Application Priority Data
Nov. 30, 2011 (ZA) 2011/08778

(51) Int. Cl. H01H 35/00; H04W 4/24; H02J 7/35

(52) U.S. Cl. 455/406; 307/116; 320/101

(57) ABSTRACT

This invention relates to an apparatus and method for controlling electrical energy supply to one or more peripheral devices. The apparatus includes a first input operable to receive electrical energy from an electrical energy source and a battery operable to store the received electrical energy. The apparatus further includes at least one output operable to supply electrical energy to at least one peripheral device and an energy management controller operable to control the supply of electrical energy to the at least one peripheral device. The apparatus also includes a communications module operable to detect the purchase of prepaid airtime associated with the apparatus, with the energy management controller activating the peripheral device(s) for as long as there is sufficient airtime and deactivating the peripheral device(s) once the airtime has expired.

### FIELD OF INVENTION

This invention relates to a system for controlling the supply of electrical energy to one or more peripheral devices using prepaid airtime.

### BACKGROUND OF INVENTION

In developing countries, such as South Africa, there is a pressing need for an electrical energy source which is both affordable and cost-efficient, and is easy to maintain. Conventionally, renewable energy sources which generate electrical energy from other forms of energy, such as solar energy, have played a significant role in this regard.

Underprivileged and/or rural communities in particular have a need for such an energy source, but traditional payment mechanisms for electrical energy are not well suited to underprivileged and/or rural communities. The concept of prepaid airtime, however, is well known and understood, and so one of the aims of the present invention is to make of use of prepaid airtime to pay for a basic supply of electrical energy to power.

### SUMMARY OF INVENTION

According to one aspect of the invention, there is provided an apparatus for controlling electrical energy supply to one or more peripheral devices, the apparatus including:
a first input operable to receive electrical energy from an electrical energy source;
a battery operable to store the received electrical energy;
at least one output operable to supply electrical energy to at least one peripheral device;
an energy management controller operable to control the supply of electrical energy to the at least one peripheral device; and
a communications module operable to detect the purchase of prepaid airtime associated with the apparatus, with the energy management controller activating the peripheral device(s) for as long as there is sufficient airtime and deactivating the peripheral device(s) once the airtime has expired.

In an embodiment, the first input is connected to a solar panel array to generate electrical energy using solar energy.

In an embodiment, the peripheral device includes a battery charger and a plurality of lights, for example four lights.

In an embodiment, the communications module is in communication with a remote system via a communications network, the remote system managing the payment of the prepaid airtime and the activation of the apparatus.

In an embodiment, the communications network is a mobile telecommunications network, for example a GSM network, with the communications module comprising a SIM card to facilitate communications via the network, and the remote system is a mobile operator system, so that the apparatus is linked into the mobile operator system.

In an embodiment, the apparatus includes a logging module operable to:
measure and log the energy usage, and in particular the energy consumed by, and the efficiency of, the peripheral device(s);
log the energy feed from the solar panel array to the energy management controller and battery;
log the battery condition; and/or
log the ambient temperature and humidity.

In one version, this logged information is sent to the remote system by the communications module for recordal and management.

In an embodiment, the apparatus includes a tampering detector, which upon detecting a tamper condition, instructs the energy management controller to deactivate the apparatus, or at least the output thereof, and thus any peripheral device(s) connected thereto. In one version, the detection of a tampering condition is sent to the remote system by the communications module for recordal and, if need be, remedial action.

In an embodiment, the communications module is operable to detect when the apparatus is out of network coverage, and if the apparatus is out of network coverage for longer than a predetermined period of time, the communications module is operable to instruct the energy management controller to deactivate the apparatus, or at least the output thereof, and thus any peripheral device(s) connected thereto.

In an embodiment, the apparatus includes a light sensor operable to measure the ambient light intensity, and if the ambient light intensity is greater than a predetermined amount, the light sensor is operable to instruct the energy management controller to deactivate the apparatus, or least the output thereof, and in particular any peripherals connected thereto, such as lights.

In an embodiment, the apparatus comprises a display operable to display at least one of the following system parameters to a user:
battery condition;
charge status;
low energy level;
low battery power;
low credit balance; and
network communication status.

The apparatus may also include a user interface operable to receive a user input.

According to another aspect of the invention, there is provided a method for controlling electrical energy supply to one or more peripheral devices, the method including:
receiving electrical energy from an electrical energy source via a first input;
storing the received electrical energy in a battery;
supplying electrical energy to at least one peripheral device via at least one output;
controlling by an energy management controller the supply of electrical energy to the at least one peripheral device;
detecting by a communications module the purchase of prepaid airtime associated with the apparatus;
activating by the energy management controller the peripheral device(s) for as long as there is sufficient airtime; and
deactivating the peripheral device(s) once the airtime has expired.

### BRIEF DESCRIPTION OF DRAWINGS

The invention will now be further described, by way of example, with reference to the accompanying diagrammatic drawings.

In the drawings:

FIG. 1 shows a schematic block diagram of an apparatus operable to control electrical energy supply to one or more peripheral devices using prepaid airtime, according an embodiment of the present invention; and

FIG. 2 shows a flow diagram of a method of controlling electrical energy supply to one or more peripheral devices using prepaid airtime, according an embodiment of the present invention.

### DETAILED DESCRIPTION

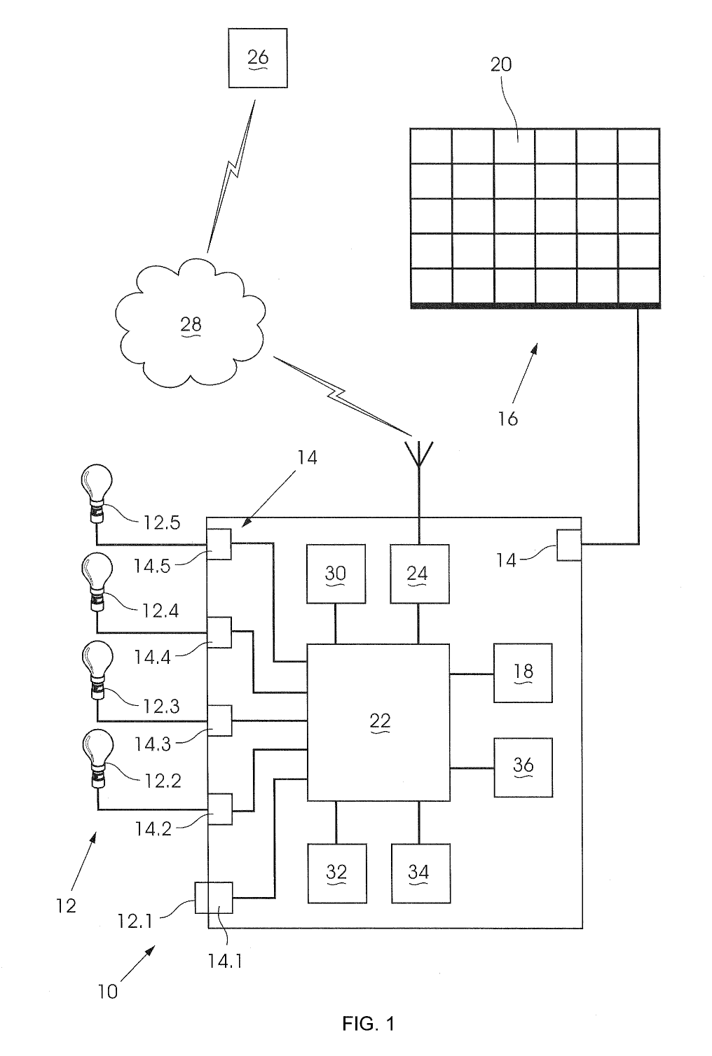

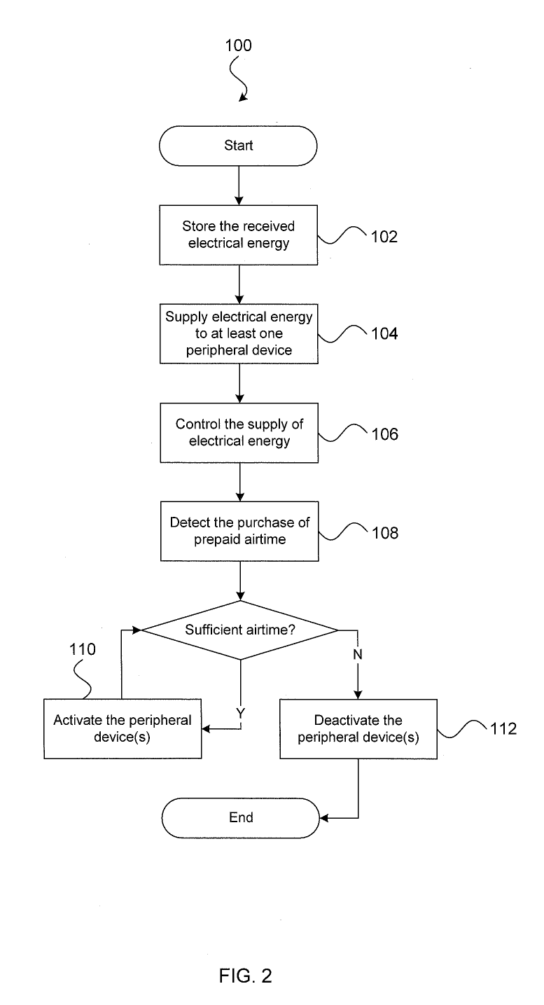

Referring to FIG. 1, an apparatus 10 for controlling electrical energy supply to one or more peripheral devices 12 using prepaid airtime, in accordance with the invention, is shown. Referring to FIG. 2, a flow diagram 100 of a method of controlling electrical energy supply to one or more peripheral devices using prepaid airtime, in accordance with the invention, is shown. It will be appreciated that the apparatus 10 could implement a different method while the method 100 could be implemented on a different apparatus, but this example is further described with reference to both the apparatus 10 and the method 100.

The apparatus 10 comprises a first input 14 to receive electrical energy from an electrical energy source 16, and a battery 18 to store (at block 102) the received electrical energy. In an embodiment, the first input 14 is connected to a solar panel array 20 to generate electrical energy using solar energy.

The apparatus 10 comprises at least one output 14 to supply (at block 104) electrical energy to the at least one peripheral device 12. In an embodiment, the at least one peripheral device 12 comprises a battery charger 12.1 connected to output 14.1, and a plurality of lights 12.2, 12.3, 12.4 and 12.5, preferably four lights, connectable to outputs 14.2, 14.3, 14.4 and 14.5, respectively.

The apparatus 10 comprises an energy management controller 22 to control (at block 106) the supply of electrical energy to the peripheral devices 12. A communications module 24 is also provided to detect (at block 108) the purchase of prepaid airtime associated with the apparatus 10, with the energy management controller 22 activating (at block 110) the peripheral devices 12 for as long as there is sufficient airtime and deactivating (at block 112) the peripheral devices 12 once the airtime has expired.

In an embodiment, the communications module 24 is in communication with a remote system 26 via a communications network 28. The remote system 26 manages the payment of the prepaid airtime and the activation of the apparatus 10. In particular, the communications network 28 is a GSM network with the communications module 24 comprising a SIM card to facilitate communications. In addition, the remote system 26 is a mobile operator system, so that the apparatus 10 is integrated into the mobile operator system.

Conveniently, the remote system 26 can remotely upgrade the firmware of the apparatus 10.

The apparatus 10 is reliable and robust, and it can, for example, replenish one day's energy usage after the use of five hours on each of the four lights, and the recharging of two cell phones, at half of the available sunlight, in the least available sunlight hours in a day, in the worst month of the year. In one version, the battery 18 has sufficient energy storage for 13 hours continuous running time with all 4 lights 12.2-12.5 being used.

In an embodiment, the apparatus 10 comprises a logging module 30 to:
measure and log the usage time, and in particular the energy consumed by, and the efficiency of, the peripheral devices 12;
log the energy feed from the solar panel array 20 to the energy management controller 22 and battery 18;
log the battery condition; and
log the ambient temperature and humidity.

In one version, this logged information is sent to the remote system 26 by the communications module 24 for recordal and management.

In an embodiment, the apparatus 10 comprises a tampering detector 32, which upon detecting a tamper condition, instructs the energy management controller 22 to deactivate the outputs 14 and thus the peripheral devices 12. In one version, the detection of a tampering condition is sent to the remote system 26 by the communications module 24 for recordal and, if need be, remedial action.

In an embodiment, the communications module 24 can detect when the apparatus 10 is out of GSM coverage. If the apparatus 10 is out of GSM coverage for longer than a predetermined period of time, the communications module 24 instructs the energy management controller 22 to deactivate the outputs 14 and thus the peripheral devices 12.

The apparatus 10 may comprise a light sensor 34 to measure the ambient light intensity. If the ambient light intensity is greater than a predetermined amount, the light sensor 34 instructs the energy management controller 22 to deactivate the outputs 14.2-14.5 and in particular the lights 12.2-12.5 (thereby protecting the user against wasting electrical energy).

The apparatus 10 may comprise a display 36 to display the following system parameters to a user: battery condition, charge status, low energy level, low battery power, low credit balance, and GSM communication status.

The apparatus of the present invention is thus designed to supply reliable and affordable light, with a built in cellular phone charger, to underprivileged community members, on a pay as you use basis.

1. An apparatus for controlling electrical energy supply to one or more peripheral devices, the apparatus including:
a first input operable to receive electrical energy from an electrical energy source;
a battery operable to store the received electrical energy;
at least one output operable to supply electrical energy to at least one peripheral device;
an energy management controller operable to control the supply of electrical energy to the at least one peripheral device; and
a communications module operable to detect the purchase of prepaid airtime associated with the apparatus, with the energy management controller activating the peripheral device(s) for as long as there is sufficient airtime and deactivating the peripheral device(s) once the airtime has expired.

2. An apparatus as claimed in claim 1, in which the first input is connected to a solar panel array to generate electrical energy using solar energy.

3. An apparatus as claimed in claim 1, in which the peripheral device includes a battery charger and a plurality of lights.

4. An apparatus as claimed in claim 1, in which the communications module is in communication with a remote system via a communications network, the remote system managing the payment of the prepaid airtime and the activation of the apparatus.

5. An apparatus as claimed in claim 4, in which the communications network is a mobile telecommunications network with the communications module comprising a SIM card to facilitate communications via the network, and the remote system is a mobile operator system, so that the apparatus is linked into the mobile operator system.

6. An apparatus as claimed in claim 4, which includes a logging module operable to:
measure and log the energy usage, and in particular the energy consumed by, and the efficiency of, the peripheral device(s);
log the energy feed from a solar panel array (if present) to the energy management controller and battery;
log a condition of the battery (if present); and/or
log the ambient temperature and humidity.

7. An apparatus as claimed in claim 6, in which the logged information is sent to the remote system by the communications module for recordal and management.

8. An apparatus as claimed in claim 4, which includes a tampering detector, which upon detecting a tamper condition, instructs the energy management controller to deactivate the apparatus, or at least the output thereof, and thus any peripheral device(s) connected thereto.

9. An apparatus as claimed in claim 8, in which the detection of a tampering condition is sent to the remote system by the communications module for recordal and, if need be, remedial action.

10. An apparatus as claimed in claim 1, in which the communications module is operable to detect when the apparatus is out of network coverage, and if the apparatus is out of network coverage for longer than a predetermined period of time, the communications module is operable to instruct the energy management controller to deactivate the apparatus, or at least the output thereof, and thus any peripheral device(s) connected thereto.

11. An apparatus as claimed in claim 1, which includes a light sensor operable to measure the ambient light intensity, and if the ambient light intensity is greater than a predetermined amount, the light sensor is operable to instruct the energy management controller to deactivate the apparatus, or at least the output thereof, and in particular any peripherals connected thereto.

12. An apparatus as claimed in claim 1, which includes a display operable to display at least one of the following system parameters to a user:
battery condition;
charge status;
low energy level;
low battery power;
low credit balance; and
network communication status.

13. A method for controlling electrical energy supply to one or more peripheral devices, the method including:
receiving electrical energy from an electrical energy source via a first input;
storing the received electrical energy in a battery;
supplying electrical energy to at least one peripheral device via at least one output;
controlling by an energy management controller the supply of electrical energy to the at least one peripheral device;
detecting by a communications module the purchase of prepaid airtime associated with the apparatus;
activating by the energy management controller the peripheral device(s) for as long as there is sufficient airtime; and
deactivating the peripheral device(s) once the airtime has expired.
